(19) United States
(12) Patent Application Publication
(10) Pub. No.: US 2007/0276923 A1
(43) Pub. Date: Nov. 29, 2007

(54) Printed publication with an interface to a video or audio device

(76) Inventor: Donald Spector, New York, NY (US)

Correspondence Address: Glen M. Diehl;DIEHL SERVILLA LLC, Suite 110, 77 Brant Ave., Clark, NJ, 07066, US

(21) Appl. No.: 11/588,867

(22) Filed: Oct. 28, 2006

Related U.S. Application Data
(63) Continuation-in-part of application No. 11/467,315, filed on Aug. 25, 2006.
Application No. 11/467,315 is a continuation-in-part of application No. 11/464,894, filed on Aug. 16, 2006.
Application No. 11/464,894 is a continuation-in-part of application No. 11/440,934, filed on May 25, 2006.

(51) Int. Cl. G06F 15/16

(52) U.S. Cl. 709/217

(57) ABSTRACT

A book with a USB connection is provided. The book also has a memory and optionally a processor. One or more documents are stored in the memory. When the book is connected to a personal computer, the documents can be displayed on the personal computer. The documents can be modified and stored on the memory in the book for later use by the book's owner. A server can also be connected to the personal computer and the progress of a plurality of students with books can be monitored. Educational systems and methods are also disclosed.

### STATEMENT OF RELATED CASES

This application is a continuation-in-part of U.S. patent application Ser. No. 11/467,315, filed Aug. 25, 2006, which is a continuation-in-part of U.S. patent application Ser. No. 11/464,894, filed Aug. 16, 2006, which is a continuation-in-part of U.S. patent application Ser. No. 11/440,934, filed May 25, 2006, all of which are hereby incorporated by reference.

### FIELD OF THE INVENTION

This application relates to the field of books and to educational systems and methods.

### BACKGROUND OF THE INVENTION

Learning from a text book can be difficult and limiting. People learn through different mechanisms. Some people simply read and remember, others need to take copious notes from a text book to learn. Others learn better through visual and pictorial presentations of information. A simple text book does not offer a full range of teaching mechanisms that can be helpful to students. Also, it can be difficult to organize all of the additional references or information obtained from sources other than the textbook.

Long distance educational systems and methods can also be difficult to implement. It is difficult to track the progress of various students.

Accordingly, new and improved books and educational systems and methods are needed.

### SUMMARY OF THE INVENTION

One aspect of the present invention is an article that includes a book, a memory on the book and a connector on the book electronically connected to the memory and capable of providing an interface to a computer.

In accordance with another aspect of the present invention, the connector is a USB connector. In accordance with a further aspect of the present invention, the book has a spine and the USB connector is on the spine.

In accordance with yet another aspect of the present invention, one or more documents related to the contents of the book are stored in the memory. The documents include a worksheet related to the book, problems related to the book and/or notes related to the book. The notes can be generated by a user.

In accordance with a further aspect of the present invention, the book also includes a processor connected to the memory and the connector.

The present invention also contemplates an application being stored on the memory and is operable on the processor to instruct a personal computer.

The present invention also contemplates an educational system that includes a personal computer and a book having a memory and a connector capable of being connected to the personal computer, with one or more documents stored on the memory. When the book is connected to the personal computer through the connector, the one or more documents are transferred from the memory to the personal computer.

In accordance with another aspect of the present invention, an object from the personal computer can be stored on the memory on the book. The object can be a modified version of one of the one or more documents.

The one or more documents can be selected from the group consisting of: worksheets, problems, notes generated by a user, and/or combinations thereof.

In accordance with further aspects of the invention, the system further includes a server connected to the personal computer, wherein the personal computer can transfer the one or more documents to the server and the server monitors a user's progress through the book. The server can also transfer the one or more documents to the personal computer.

The present invention also contemplates an educational method that includes the steps of transferring a document from a book to a personal computer, transferring the document form the personal computer to a server and monitoring a user's progress through the book at the server based on the document. The documents can be selected from the group consisting of: worksheets, problems and notes generated by a user. The present invention also includes transferring a modified version of the document from the personal computer to the book.

In accordance with a further aspect of the present invention, an article that can be connected to a computing device is provided. The article includes a printed publication and a connector connected to the printed publication. The connector has an interface circuit to the computing device and a memory. The connector can also include a processor.

The computing device can be a number of different devices, including a personal computer, a radio, a music playing device, an iPod, a portable computing device, such as a laptop computer, or any other type of computing device.

The interface circuit can provide an interface to any of the standard computer interfaces. By way of example, the interface can be provided to the computer via a serial port, via a parallel port, via a USB port, via a PCI port or via any other available port.

In accordance with another aspect of the present invention, the interface circuit can be a PCMCIA card or a Memory Stick. The interface circuit can also be a jump drive that can be connected to the USB port, the jump drive including a USB interface controller, a processor and a memory. Alternatively, the controller, the processor and the memory can be provided as specially designed circuits to minimize or maximize a desired attribute.

The connector preferably a housing for the memory and the interface circuit and for the processor.

In accordance with further aspects of the present invention, the memory stores information relating to the subject matter of the printed publication. The memory can also store an internet address of a site having information relating to the subject matter of the printed publication. The memory can further store a key that allows access to the site.

### DESCRIPTION OF THE DRAWINGS

FIG. 1 illustrates a book and an educational system in accordance with one aspect of the present invention.

FIG. 2 illustrates a circuit on a book in accordance with an aspect of the present invention.

FIG. 3 illustrates a plurality of documents stored on a memory on the book in accordance with a further aspect of the present invention.

FIG. 4 illustrates a roster of students used to monitor the progress of students at a server in accordance with an aspect of the present invention.

FIG. 5 illustrates another circuit that can be located on a book in accordance with a further aspect of the present invention.

FIGS. 6 and 7 illustrate a book with a jump drive or a USB device in accordance with another aspect of the present invention.

FIG. 8 illustrates the book of FIGS. 6 and 7 connected to a computing device.

FIG. 9 illustrates another aspect of the present invention wherein a content server and an advertising server are connected to a printed publication.

FIG. 10 illustrates another aspect of the present invention.

FIG. 11 illustrates a book having a connector in accordance with one aspect of the present invention connected to a computing device.

FIG. 12 illustrates an embodiment of the connector in accordance with another aspect of the present invention.

### DESCRIPTION OF A PREFERRED EMBODIMENT

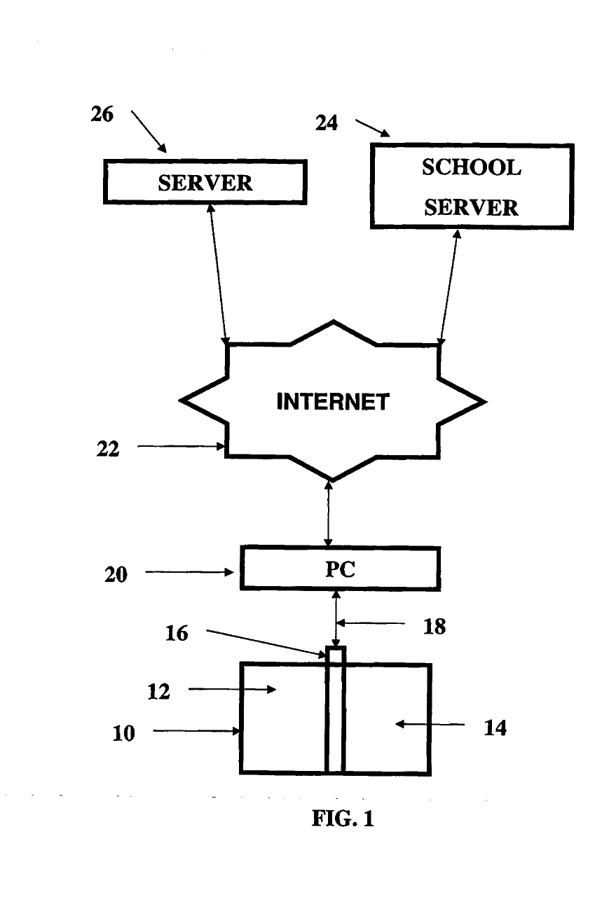

FIG. 1 illustrates an education system. The system includes a book 10 having a left side 12, a right side 14 and a spine 15. A connector 16 is attached to the book 10, preferably on the spine 15 of the book 10, although it can be attached anywhere on the book 10.

The connector 16 is preferably a USB connector.

A cable 18 can connect the book 10 to a personal computer 20. The personal computer 20 is connected to a network, such as the internet 22. A plurality of servers 26 are connected to the internet 22. A school's server 24 is also connected to the internet 22. Thus, the servers 24 and 26 are connected to the book 10 through the internet 22 and the personal computer 20.

Any type of connector 16 can be used. For example, the connector 16 can be a wireless transceiver that connects to a personal computer 20. While the connection—by wire or wireless—can be made directly to the personal computer 20, it can also connect to another personal computer via the internet 22 or to any server 26 on the internet.

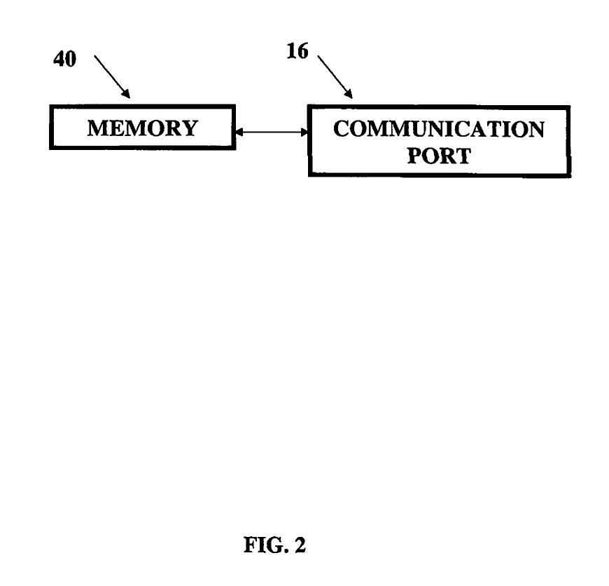

FIG. 2 illustrates a circuit that is located on the book 10 in accordance with one aspect of the present invention. The book 10 preferably has a memory 40 that is connected to a connector or communication port 16. In accordance with one aspect of the present invention, one or more documents related to the contents of the book are stored in the memory 40.

The memory 40 can also be located on the spine 15 of the book 10. The memory 40 and the connector 16 can be attached by an adhesive or by other means. For example, the memory 40 and the connector 16 can be attached inside a cover of the book 10 by adhesive. The can also be attached to a special page or to an insert during the manufacturing process.

The one or more documents can include a worksheet related to the book 10. They can also include problems related to the book. They can also include notes related to the book. Typically, the notes are generated by a user on a personal computer 20 when the user is reading the book or other sources and the notes can be stored on the memory 40 of the book 10. The notes can be stored as a template in the memory 40 for use by a user.

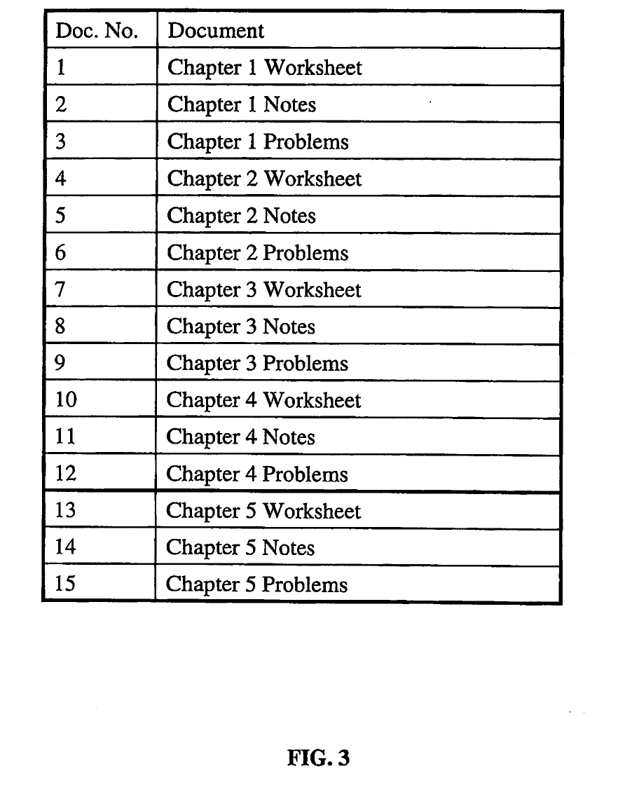

An example of the one or more documents stored on the memory 40 is illustrated in FIG. 3. There are fifteen documents stored on the memory. The first document is a worksheet based on the contents of chapter 1 in the book 10. The worksheet is a programmed review of the contents of chapter 1. The second document is notes from chapter 1 of the book 10. The document can be a blank document or it can be in template form. The notes document can be modified by a user, typically on the personal computer 20 and then stored on the memory 40 of the book 10 in a modified form. The third documents are problems related to the contents of chapter 1 of the book 10. Documents 4 to 15 are similar documents relating to chapters 2 to 5 of the book 10.

The documents from the memory 40 on the book 10 can be used, manipulated and modified by an owner of the book 10 while studying the book. Typically, the owner would use the documents on the personal computer 20 and store the documents, as modified, on the memory 40 in the book 10.

The documents can also be sent by the personal computer 20 to the school server 24 once they are completed by an owner of the book 10. The school server 24 can check on the progress of the book owner. If the book owner is a student in a class at the school, the school can conduct effective long distance learning by checking the progress of the book owner.

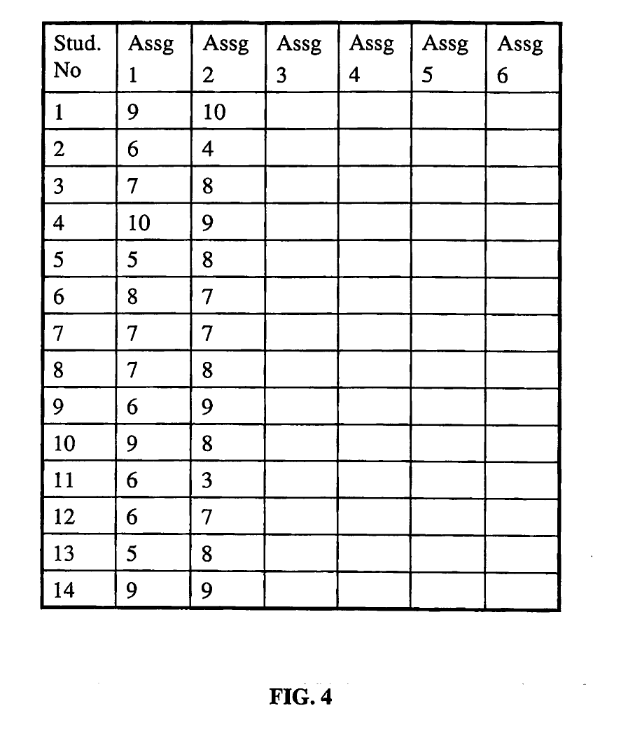

FIG. 4 illustrates a database maintained by the school server 24. The school server 24 can track the progress of a number of students in accordance with the present invention. In FIG. 4, there are fourteen students being tracked. During a semester, there will be six assignments, which could include homework, tests, worksheets, problem sets and the like. The first two assignments have been completed and every student has submitted a document through a personal computer 20 to the school server 24. Grades have been entered into the database of FIG. 4 for each student for each of the first two assignments. In this fashion, the progress of the students can be tracked by the school server 24.

The school server 24 can also submit documents to be stored on the memory 40 of the book 10. The server 24 would typically first transmit the documents to the personal computer 20, which would then transmit the documents to the memory 40 on the book 10. These documents could be comments from a teacher, progress reports or other communications to the student or owner of the book 10.

The owner of the book 10 can also connect to other servers 26 via the internet 22 to obtain further information about the subject of the book 10. The memory 40 may include a listing of sites and a link to those sites so that the book owner can easily access the sites by clicking on a document that has been transmitted from the memory 40 on the book 10 to the personal computer 20. The documents from various servers 26 can also be stored on the memory 40 of the book 10.

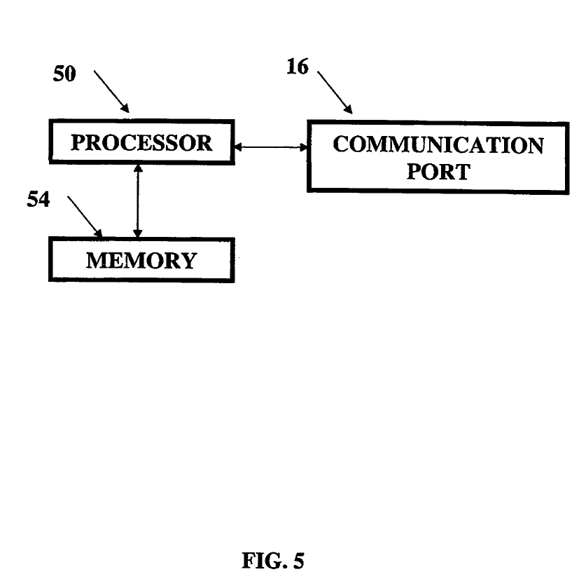

FIG. 5 illustrates another embodiment of a circuit that may be found on the book 10. This circuit includes the communication port 16 which is preferably a USB port. It also includes a processor 50 connected to the port 16 and a memory 54 connected to the processor 50. The memory 54 can store the previously referred to documents. It can also store application software that can be accessed by the processor 50. The application software can be downloaded to the personal computer 20 or processed by the processor 50. The memory 40 from FIG. 2 can also hold application software that can be downloaded to the personal computer 20.

The processor 50 is preferably located near the memory 54 and the connector 16. These components can be located in the same places as previously discussed with respect to the memory 40.

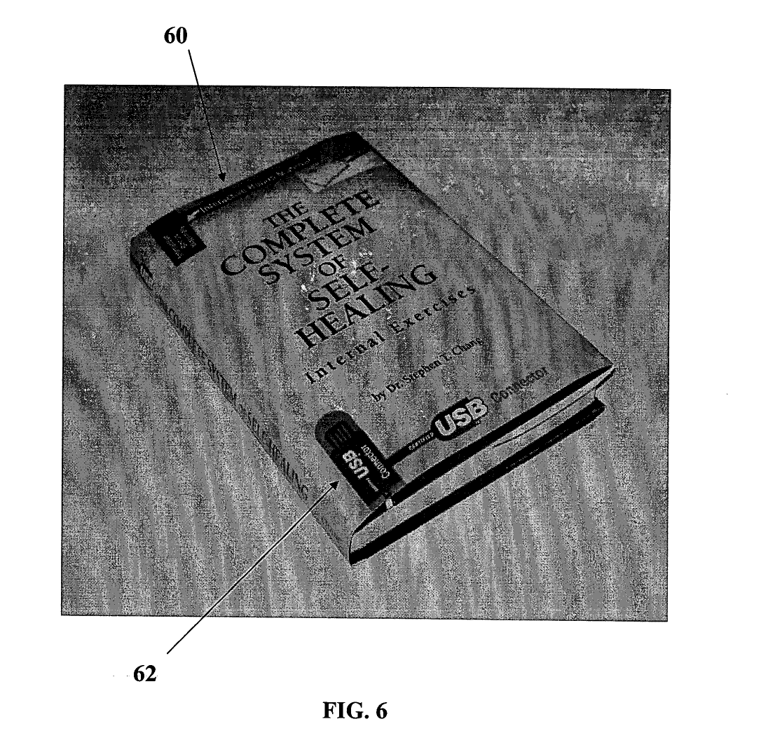

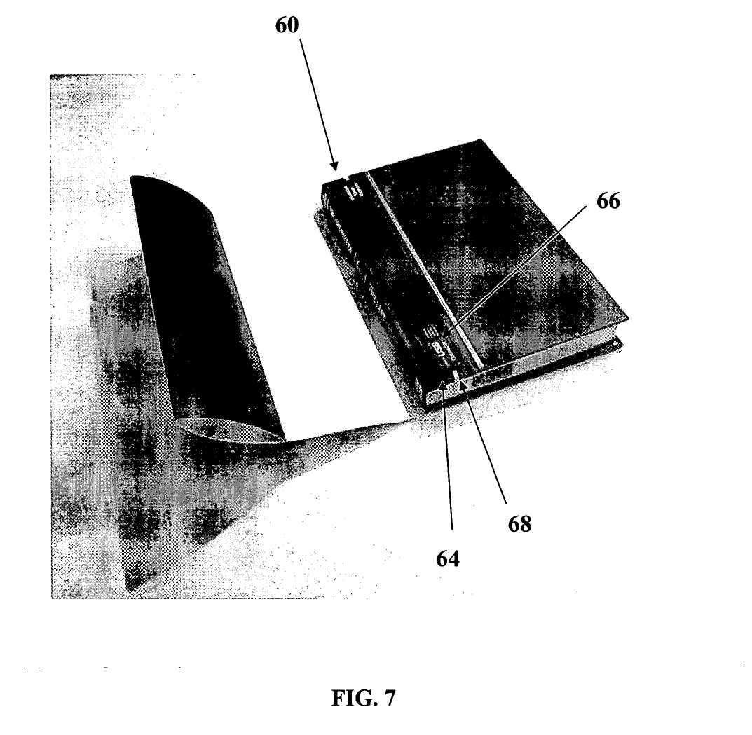

FIGS. 6 and 7 illustrate another aspect of the present invention. A book 60 has a cover and an indication 62 on the cover that the book 60 is a USB book. FIG. 7 illustrates the book 60 with the cover partially removed. The front cover of the book 60 has an indentation 64 that holds a USB device/jump drive 66 with a cord 68.

The indentation 64 can also be located in the back cover of the book 60. The indentation 64 can also be located in a special page of the book 60 or even in the spine of the book 60.

The indentation 64 preferably has two or more clips that hold the USB device/jump drive 66 in place. When the USB device/jump drive 66 is placed in the holder, the clips preferably engage the USB device/jump drive 66 to retain it in place.

Of course, an indentation does not have to be used, and any other holder can be used.

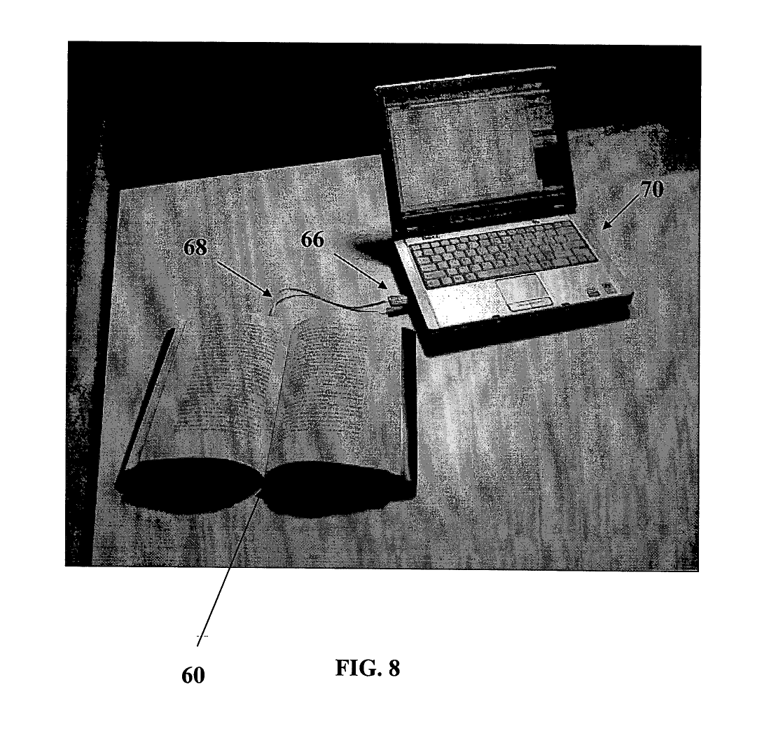

FIG. 8 illustrates the USB device/jump drive 66 connected to a laptop computer 70. The USB device/jump drive 66 has been removed from the holder 64 in the book 60 and inserted into a USB connector on the laptop computer 70. The cord 68 extends from the book 60. The cord 68 can be free from connection to the book 60, and in this case can actually be used as a book mark. Alternatively, the cord 68 can be connected at one end to the book 60 so that it is difficult to lose the USB device/jump drive 66. The connection to the book 60 can be made by glue or any other connection means. The cord 68 can also be held in a circularly wound position, held in place by a spring so that when the cord 68 is pulled out from the book 60 there is tension on the cord 68. The cord 68 can also provide an electrical connection to a processor on the book 60.

When the USB device/jump drive 66 is plugged into the laptop computer 70, the processor in the laptop computer 70 can execute the software application on the USB device/jump drive 66 to execute programs related to the book content. Documents can be downloaded onto the computer 70, links to web sties on the Internet can be made, documents from the computer 70 and web sites connected to the computer 70 can be downloaded to the flash drive 66, and an entire lesson plan can be implemented, as previously described.

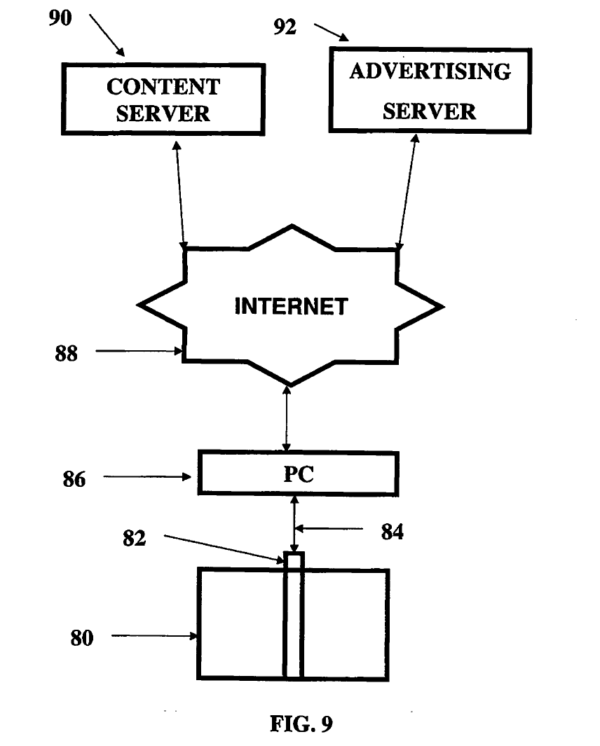

FIG. 9 illustrates another aspect of the present invention. A book 80 having a connection 82 to a computer 86 is illustrated. The connection 82 to the computer 86 is preferably a jump drive 84 that is attached by a string or other mechanism to the book 80 and that is plugged into a connector on the computer 86. Alternatively, the connection to the computer 86 can be via a USB connector on the book and a memory on the book can supply the information supplied hereinafter.

The computer 86 is connected to one or more content servers 90 and one or more advertising servers 92 via an Internet connection 88.

The jump drive 84 or the memory on the book 80 has information stored on it. In accordance with one aspect of the present invention, the information relates to the topic of the book. In accordance with another aspect of the present invention, an advertisement of a product or service related to the topic of the book is stored on the jump drive.

When the computer 86 is connected to the book 80, the information stored on the jump drive 84, or on a memory in the book 80, can be displayed on the computer. If the information is advertisements, then the advertisements can be displayed on the computer.

In accordance with another aspect of the present invention, the information on the jump drive 84 causes the computer 86 to connect to one of the servers 90 or 92. The information can be a program that is executed by the computer 86. The program has the web address for the server 90 or 92 being connected to and the computer 86, under control of the program on the storage media provided with the book 80, connects to the server under the program control.

In accordance with another aspect of the present invention, the server 90 or 92 downloads information stored on the server to the computer to be displayed by the computer. In the case of the content server 90, new content is downloaded from the server 90 to the computer 86 to be displayed on the computer 86. The new content is preferably related to the topic of the book 80 to enhance a reader's experience with the book 80. In the case of the advertising server 92, the new content downloaded from the advertising server 92 is advertisements. The advertisements preferably describe products or services related to the topic of the book 80.

The information stored on the server can be a list of a plurality of advertisements that can be selected for viewing. The list can be displayed on the computer 86 and one of the advertisements can be selected to be viewed on the computer 86. The advertisements stored on the server 92 can be periodically updated. Thus, advertisers wishing to update their advertisements can access the server 92 to store new advertisements on the server 92.

The advertisements stored on the server 92 can be pre-sold to manufacturers or service providers.

Of course, all of the information that is described as being on the servers 90 or 92 can be stored on the jump drive 84 or on a memory on the book 80.

The item 80 can be any printed publication. Thus, the item 80 can be a hard cover book, a soft cover book, a pocket edition book or a magazine, or any other printed publication. The description provided above with respect to the book also applies to these printed media. Thus, the jump drive 84 or other connector to memory on the media 80 can be stored on the spine of the media 80 or in the cover of the media 80 or on a special page in the media 80.

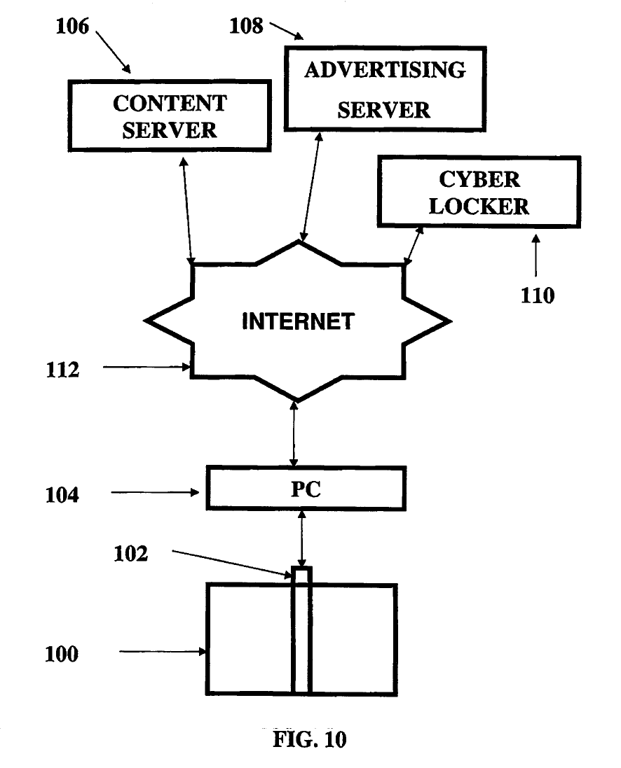

Referring now to FIG. 10, another aspect of the present invention is shown. A server 100 has an attached jump drive 102 connected to a computer 104. The computer 104 is connected to advertising servers 106, content servers 108 and a user's cyber locker space 110 through the internet 112.

In accordance with this aspect of the present invention, the jump drive 102 has a minimum amount of information stored on it. This allows the jump drive 102 to be provided with the smallest possible memory to allow it to be provided in a cost effective manner.

In accordance with one aspect of the present invention, the jump drive has a memory containing only information that is needed to allow the computer to connect to one or more servers. The memory on the jump drive is sized so that no additional information can be stored on it.

The information stored on the jump drive 102 can be a web address of a content server 108 on the internet that stores information related to the printed publication, as previously described. When the jump drive 102 is plugged into a computer 104, the computer uses the address on the jump drive to access the content server. In accordance with another aspect of the present invention the program that enables the computer to connect to the content server using the web address can also be provided on the memory on the jump drive 102. In accordance with a further aspect of the present invention, a key that allows access to the content server can also be provided on the memory on the jump drive 102. The key is also stored on the content server 108 and when the computer 104 accesses the server 108, the keys are compared. If there is a match, then access is allowed to the content server 108.

Similar information about an advertising server 106 can also be stored on memory on the jump drive 102. This information concerning the advertising server 106 can be stored by itself on the jump drive 102 or can be stored on the jump drive 102 with the information related to the content server 108. The information stored on the jump drive, in accordance with one aspect of the present invention, can be a web address of a content server 108 on the internet that stores information related to the printed publication, as previously described. When the jump drive 102 is plugged into a computer 104, the computer uses the address on the jump drive to access the advertising server. In accordance with another aspect of the present invention the program that enables the computer to connect to the advertising server 106 using the web address can also be provided on the memory on the jump drive 102. In accordance with a further aspect of the present invention, a key that allows access to the advertising server 106 can also be provided on the memory on the jump drive 102. The key is also stored on the advertising server 106 and when the computer 104 accesses the server 106, the keys are compared. If there is a match, then access is allowed to the advertising server 106.

In accordance with another aspect of the present invention, the jump drive 102 can also store information relating to a person's personal memory space 110 on the internet 112. The space 110 is referred to as a Cyber Locker storage. This memory space is commonly provided to users of an internet service, but can also be part of a paid for service.

The information relating to a person's personal memory space 110 can include the web address of the memory space 110 on the internet 112. The information can also include a program that causes the computer 104 to query a user to enter the web address of the memory space 110. Thus, when the jump drive 102 is removed from the printed publication 100 and inserted into the computer 104, the computer will prompt the user to enter the web address, which will then be stored on the jump drive 102.

The information stored on the jump drive relating a person's personal memory space 110 can also include a key that permits access to the personal memory space 110. The key can be specified by a user on the computer 104 and then stored on the jump drive 102. The key can be used by the computer 104 when accessing the personal memory space 110 to allow access to the personal memory space 110 by comparing the key stored on the jump drive 102 to the key stored by the personal memory space 110. If there is a match, then access is allowed.

The reader of the printed publication 100 can store information from the content server 108 or the advertising server 106 onto the personal memory space 110 on the internet 112. This can be done using the address information concerning the personal memory space 112 that is stored on the jump drive 102. Alternatively, the user can enter the information if it is not stored on the jump drive 102.

Of course, if the size of the memory on the jump drive 102 is not an issue, then any or all of the above mentioned information can be stored on the jump drive 102. In this case, additional information can also be stored. For example, if the printed publication is a monthly sports magazine, highlights from the past month of sports can be stored on the jump drive 102, for example, in MPEG format. Then when the jump drive 102 is removed from the printed publication 100 and inserted into a USB connector on the computer 104, the computer 104 can display the highlights.

All of the functions described herein can be performed by storing the appropriate data and the appropriate program on the jump drive 102.

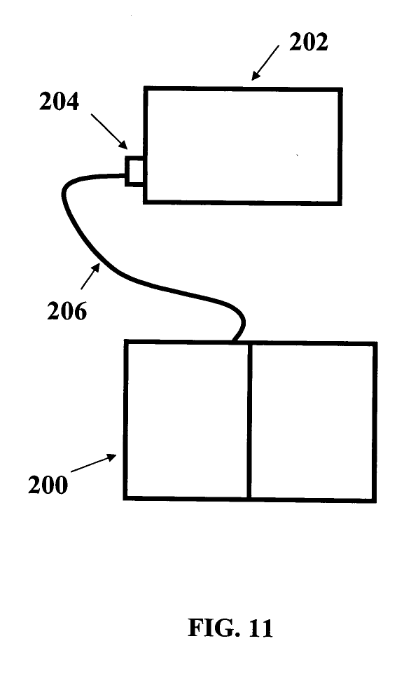

Referring to FIG. 11, further aspects of the present invention will now be discussed. A connector 204 from a printed publication, such as a book 200, is connected to a computing device 202. The connector 204 is preferably connected to the book 200, either prior to use by a receptacle or by an optional tethered string 206.

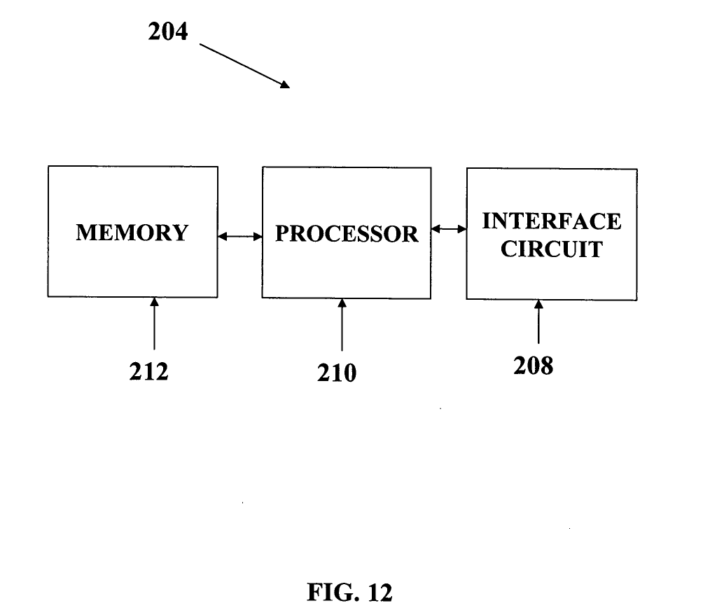

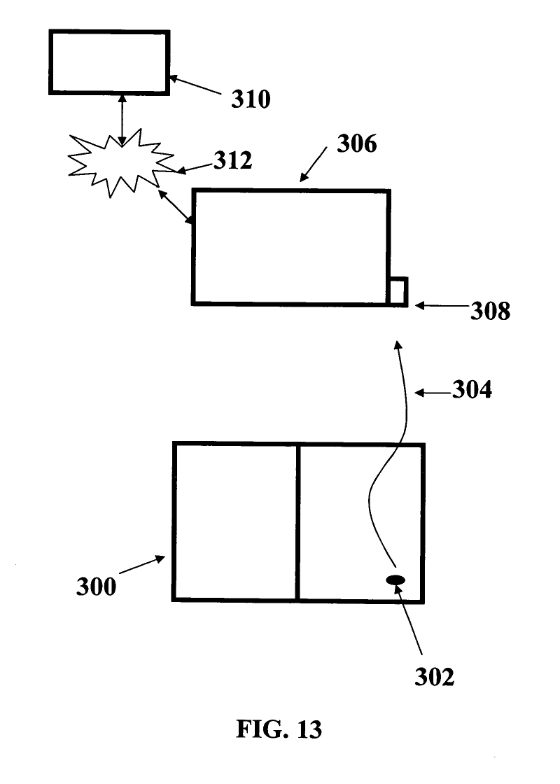

As shown in FIG. 12, the connector 204 includes an appropriate interface circuit 208, a processor 210 and a memory 212. The type of interface circuit provided depends on the type of connection to the computing device 202. The processor 210 is optional. If a passive interface to the computer 202 that does not require processor control is used, then a processor 210 is not needed. Any type of memory 212, including DRAM, SRAM, EPROM, PROM, Masked ROM, NVRAM, Flash or EEPROM, can be used.

The interface circuit 208 can be an off-the-shelf integrated circuit device specially designed for the port the connector 204 is being plugged in to. Alternatively, it can also be a specially designed circuit made from discrete components, ASICs or the like. The same is true of the processor 210.

The computing device 202 can be any number of different types of computing devices. By way of example only, it can be a personal computer, a laptop computer, a personal digital assistant (PDA), a cell phone, a radio, a cell phone, a music playing device an iPod, or any type of portable computing device, to name a few. In accordance with another aspect of the present invention, the computing device 202 can be any video or audio device. The video or audio device preferably includes memory.

The connector 204 can be constructed to plug into any of the available ports in a computer or a computing device. By way of example only, the connector 204 can plug into a serial port, a parallel port, a USB port, a PCI port. The connector 204 can also provide a wireless interface to the computer 202. For example, the connector 204 can provide a wireless USB (“WUSB”) connection to the computer 202. Any other available wireless interface can also be used.

In accordance with further aspects of the present invention, the connector 202 can be a PCMCIA card or a Memory Stick. The connector 202 can also be any other type of standard memory card.

The connector 202 preferably has a housing for the interface circuit 208, the processor 210 and the memory 212.

In accordance with a further aspect of the present invention, the memory 212 stores information relating to the subject matter of the printed publication. The memory 212 can also store an internet address of a site having information relating to the subject matter of the printed publication. The memory 212 can further store a key that allows access to the site.

In accordance with another aspect of the present invention, the memory 212 stores music related to the printed publication 200. The computing device 202 is a radio, and the radio 202 plays the stored music when the connector 204 is connected to the radio 202.

In accordance with a further aspect of the present invention, the memory 212 stores audio portions of the printed publication 202. The computing device 202 is a radio, and the radio 202 plays the audio when the connector is connected to the radio.

In these examples, the radio 202 can be a MP3 player, an iPod, a PDA or any other device that plays audio signals.

Referring to FIG. 13, a printed publication 300, such as a book, has an RFID tag 302 on it. The RFID tag 302 is shown on the front cover of the book 300 in FIG. 13, however, the RFID tag 302 can be located anywhere on the book 300.

RFID tags 302 typically communicate wirelessly and can be used, for example, to maintain inventories. Referring to FIG. 13, the RFID tag 302 sends a wireless signal 304 to a video or audio device 306. The video or audio device 306 receives the signal via a wireless interface 308. The video or audio device 306 can be any of the previously listed deices.

The RFID tag 302 has a memory on it. The memory on the RFID tag is typically small. In accordance with one aspect of the present invention, the memory stores an identification of the printed publication. In accordance with a further aspect of the present invention, the memory stores an address of an internet site. In accordance with yet another aspect of the present invention, the memory stores information related to the printed publication. The memory on the RFID tag 302 can store any combination of the above information.

In accordance with another aspect of the invention, the video or audio device is programmed to access an internet site 310 via the internet 312. The internet site has information related to the book 300 that can be accessed by the video or audio device 306. The video or audio device 306 is preferably programmed to read the signal 304 from the RFID tag 302, obtain the address of the site 310, and either provide access to the site 310 or automatically download information from the site 310 to the device 306.

The information on the RFID tag 302 could also be used to set up a Cyber Locker, as previously described herein. Additionally, any type of wireless transmission device that has a memory can be used.

A reader of the printed publication can be charged for information downloaded in accordance with the teachings of the present invention.

While it is true that education is definitely a purpose of the system and method of the present invention and, in fact, the book or printed publication of the present invention can be connected to a school server for continuing education and/or long distance learning, it can also be used for providing supplemental media information for any book or printed publication. For example, a book on Churchill might have his speeches, pictures of London, etc. stored on the memory to be played on a computer or other audio/video device, when the memory is connected thereto. As another example, a book on a sports legend may have video clips of some of his great plays etc. stored on the memory to be played on a computer or other audio/video device when the memory is connected thereto. Thus, the present invention can have plain recreational value.

As more examples a book on Billie Holiday may store have a direct connection to I tunes and a connection to an IPod. The artist's music can be either downloaded to the IPod from the memory on a book, or can be downloaded from an internet site that is accessed.

Another example would be the ability to draw from audio chapters. This is an interesting case for a person who reads three chapters and then has an hour drive. That person might want to hear the next chapter 4 on the radio and then go back to reading chapter 5. With a connection through an Ipod either through a port connection or IR this would be possible and could even be played through a car's radio.

The extra cost could be charged as needed so listening to one chapter might be $0.50 as opposed to purchasing the whole book on tape. The ability to feed through a system that can electronically connect to it's own internal memory or the Internet is the key. It is important that every transmission need not be through the Internet. In the flash memory scenario the Internet was a single option, with the micro controller it is more necessary to gain access space and information. However, the information can be PRE Accessed. This is important if a person is going on an airplane and does not have access to the Internet. However, if he knows he is going on a plane and wants the information he can have the information transferred to the Cyber Locker ahead of time so that he is really drawing on the memory of the computer, much as he would draw on the memory of the flash, during this “outage”. This material could then be automatically updated to the Internet Cyber Locker” the next time communication was made. This is an important feature since it means that the book can always be used with a device without necessarily having Internet Connection.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. An article that can be connected to a video or audio device, comprising:
a printed publication;
a device connected to the printed publication; the device having an interface circuit to the video or audio device and a memory.

2. The article of claim 1, the device further having a processor.

3. The article of claim 1, wherein the video or audio device is a personal computer.

4. The article of claim 1, wherein the video or audio device is a radio.

5. The article of claim 1, wherein the video or audio device is a music playing device.

6. The article of claim 4, wherein the music playing device is an iPod.

7. The article of claim 1, wherein the video or audio device is a portable computing device.

8. The article of claim 1, wherein the video or audio device is a cell phone.

9. The article of claim 1, wherein the interface circuit provides an interface to the computer via a serial port.

10. The article of claim 1, wherein the interface circuit provides an interface to the computer via a parallel port.

11. The article of claim 1, wherein the interface circuit provides an interface to the computer via a USB port.

12. The article of claim 1, wherein the interface circuit provides an interface to the computer via a PCI port.

13. The article of claim 1, wherein the interface circuit provides an interface to the computer via a wireless interface.

14. The article of claim 1, wherein the interface circuit is a PCMCIA card.

15. The article of claim 1, wherein the interface circuit is a Memory Stick.

16. The article of claim 1, wherein the connector has a housing for the memory and the interface circuit.

17. The article of claim 2, wherein the connector has a housing for the memory, the interface circuit and the processor.

18. The article of claim 1, wherein the memory stores information relating to the subject matter of the printed publication.

19. The article of claim 1, wherein the memory stores an internet address of a site having information relating to the subject matter of the printed publication.

20. The article of claim 19, wherein a user of the article is charged for accessing the information relating to the subject matter of the printed publication.

21. The article of claim 19, wherein the memory stores a key that allows access to the site.

22. The article of claim 4, wherein the memory stores music related to the printed publication and the radio plays the stored music when the connector is connected to the radio.

23. The article of claim 1, wherein the memory stores audio portions of the printed publication and the radio plays the audio when the connector is connected to the video or audio device.

24. The article of claim 1, wherein the device is an RFID tag.

25. The article of claim 24, wherein the interface circuit provides a wireless interface to the video or audio device.

26. The article of claim 25, wherein the memory stores an identification of the printed publication.

27. The article of claim 25 wherein the memory stores an address of an internet site.

28. The article of claim 25, wherein the memory stores information related to the printed publication.

29. The article of claim 27, wherein the memory stores information related to the printed publication.

30. The article of claim 27, wherein the video or audio device is programmed to access the internet site and the internet site has information related to the printed publication that can be accessed by the video or audio device.
